(19) United States
(12) Patent Application Publication
(10) Pub. No.: US 2012/0090035 A1
(43) Pub. Date: Apr. 12, 2012

(54) System and Tool for Logistics Data Management on Secured Smart Mobile Devices

(75) Inventors: Rajiv P. MEHTA, Fort Collins, CO (US); Eric (Ric) STARCK, Galesburg, MI (US); Eric STRAND, Fort Collins, CO (US); Helen Barbara MASON, Cheyenne, WY (US)

(73) Assignee: SYNERGETICS INCORPORATED, Fort Collins, CO (US)

(21) Appl. No.: 13/272,202

(22) Filed: Oct. 12, 2011

Related U.S. Application Data
(60) Provisional application No. 61/392,468, filed on Oct. 12, 2010.

(51) Int. Cl. H04L 9/00; G06F 15/16

(52) U.S. Cl. 726/26

(57) ABSTRACT

A unique computer implemented logistics data management tool/technique for secure resident operation on a mobile computerized device—and associated system and computer-readable storage medium having stored thereon, executable program code and instructions—encompassing certain cornerstone modules: product generation module; data update module; and secure services module. Features of the three modules interoperate for secure downloading to the mobile computerized device for resident operation thereon whether in any of the following categories of wireless communication: Connected, Disconnected, and Occasionally Connected.

### CROSS REFERENCE TO RELATED APPLICATIONS

This application claims benefit under 35 U.S.C. 119(e) of pending U.S. Provisional Application No. 61/392,468 filed 12 Oct. 2011 by the applicants on behalf of the assignee, the complete disclosure of which—including attached materials—is incorporated herein by reference, to the extent the disclosure provides support and further edification hereof.

### FIELD OF THE INVENTION

In general, the present invention relates to computer implemented data logistics systems, and associated methods for use on a computerized apparatus, for searching, retrieving, and management of large volumes of fielded data. As is well understood, logistics refers to the flow of goods or services between one point (e.g., point of origin) to a second point (e.g., the point of use, whether it be use to incorporate into a module or product for consumption or use, for further transport for additional builds at some next point, and so on). Logistics involves the integration and use of information, transportation, inventory, warehousing, material handling, packaging, and so on.

The invention is directed, more-particularly, to a new technology for secure resident application/use and operation on portable/mobile computerized devices known, generally, as smart mobile devices. The term ‘smart mobile device’ has been coined to include a wide variety of portable/mobile devices with computer processing capability that are often characterized as having a small footprint for handy transport and operation under a wide range of suitable environmental conditions indoors and out, as well as fit into an average-sized adult human hand (e.g., smartphone or other personal desk assistant, PDA), or fit into a purse, backpack or other carry-all (in the case of a tablet computer). Disclosed, herein, is a unique tool—utilized as an integral part of a method or computerized system—for use on such mobile computerized devices for management (searching, retrieval, and updating) of large volumes of fielded data. The volume(s) of data may undergo an initial loading by the mobile device or may be part of existing usable logistical data sets currently maintained remotely, elsewhere (e.g., being maintained in ‘the cloud’ on one or more remote interconnected host/servers, resident in storage of one or more remote clients in communication, resident on one or more interoperable mobile devices, and so on). The following is offered to better appreciate the size of retrievable data sets targeted for management (search, retrieval, and updating) according to the instant invention, locally on a mobile device: Retrievable data sets may contain up to, and over, eight to ten million unique items with thousands of images and are used by over 300,000 users worldwide. The tool capabilities are robust and securable.

The unique computer implemented logistics data management tool/technique for secure resident operation on a mobile computerized device—and associated system and computer-readable storage medium having stored thereon, executable program code and instructions—encompasses certain cornerstone modules: product generation module; data update module; and secure services module. Features of the three modules interoperate for resident logistics data management on the mobile computerized device whether in any of three environment categories: Connected, Disconnected, and Occasionally Connected.

### BACKGROUND OF THE INVENTION—HISTORICAL PERSPECTIVE

Goyal, et al. U.S. Publication No.: 2009/0240947 “System and Method for Securely Accessing Mobile Data” published 24 Sep. 2009 targets the “somewhat intrusive ‘what the user knows’ re-authentication factor with a less intrusive ‘what the user possesses’ re-authentication factor” as Goyal, et al. states:
Because current re-authentication processes utilize a single authentication factor, it is an object of the present invention to increase the convenience of lease key renewals by shifting the single authentication factor from something the user knows (e.g., user credential's such as user name and password combination) to something the user possesses (e.g., another piece of hardware that the user typically carries along with the mobile device such as a headset) [para [0015]].
. . . Two-factor authentication is an authentication process that utilizes at least two authentication factors, such as information that the user knows (e.g., user credentials); an object or thing that the user possesses (e.g., an accessory to the mobile device, such as a headset); or a unique and naturally occurring feature that the user possesses (e.g., a fingerprint, a retina) [para [0011]].

The background technology materials labeled ATTACHMENT A and incorporated with applicants' Prov. App No. 61/392,468 describes a conventional web-accessed logistics component look-up/management product branded and distributed by IHS, Inc. as Haystack® Gold that permits classic search/indexing and access to parts information stored in a host or mainframe computer system for use by “both government organizations and commercial contractors.” The authors of the content labeled ATTACHMENT A of applicants' Prov. App No. 61/392,468 refer to Haystack® Gold as a “complete parts and logistics information management system.” As one can appreciate, the sheer size of the logistics data/information accessed by Haystack® Gold makes it inaccessible for running, locally—i.e., for resident use—on a smart mobile device designed for use on a remote basis in-the-field.

No conventional smart mobile device app/technique/solution exists for resident application/use on a mobile computerized device that is capable of accessing and handling a large volume of confidential/sensitive data in a suitably secure manner when in an environment that can change from connected to disconnected. The flexible tool is operable both in a ‘connected environment’ (i.e., the mobile device is within range to directly access, and does in fact directly access whether done so in a wireless or wired fashion, a Local

Area Network, LAN, or Wide Area Network, WAN, such as the INTERNET), and in a ‘disconnected environment’ (i.e., those times when the mobile device is not in direct communication with a LAN nor a WAN, whether the mobile device is within range of a network). Operation of the instant new technique/tool and associated system permits troops located in the field, on-site emergency personnel, researchers, expedition/explorers, and so on, to retrieve information in harsh, restricted or unconnected environments, i.e., no wired or wireless connection to a WAN (such as the INTERNET) or LAN (comprised of a closed network of hosts/servers) from which sensitive data needs to be accessed, searched, and updated (i.e., ‘managed’) on a mobile device, where conventional computing equipment is impractical or impossible to access.

### Computerized Devices, Memory and Storage Devices/Media

I. Digital computers. A processor is the set of logic devices/circuitry that responds to and processes instructions to drive a computerized device. The central processing unit (CPU) is considered the computing part of a digital or other type of computerized system. Often referred to simply as a processor, a CPU is made up of the control unit, program sequencer, and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. The CPUs of a computer may be contained on a single ‘chip’, often referred to as microprocessors because of their tiny physical size. As is well known, the basic elements of a simple computer include a CPU, clock and main memory; whereas a complete computer system requires the addition of control units, input, output and storage devices, as well as an operating system. The tiny devices referred to as ‘microprocessors’ typically contain the processing components of a CPU as integrated circuitry, along with associated bus interface. A microcontroller typically incorporates one or more microprocessor, memory, and I/O circuits as an integrated circuit (IC). Computer instruction(s) are used to trigger computations carried out by the CPU.
II. Computer Memory and Computer Readable Storage. While the word ‘memory’ has historically referred to that which is stored temporarily, with storage traditionally used to refer to a semi-permanent or permanent holding place for digital data—such as that entered by a user for holding long term—however, the definitions of these terms have blurred. A non-exhaustive listing of well known computer readable storage device technologies compatible with a variety of computer processing structures are categorized here for reference: (1) magetic tape technologies; (2) magnetic disk technologies include floppy disk/diskettes, fixed hard disks (often in desktops, laptops, workstations, host computers and mainframes interconnected to create a ‘cloud’ environment, etc.), (3) solid-state disk (SSD) technology including DRAM and ‘flash memory’; and (4) optical disk technology, including magneto-optical disks, PD, CD-ROM, CD-R, CD-RW, DVD-ROM, DVD-R, DVD-RAM, WORM, OROM, holographic, solid state optical disk technology, etc.
III. Layers of Common Networking Protocol Frameworks. The item labeled EXHIBIT A is incorporated herein by reference for purposes of providing background technical summary information about the layers of common networking protocol frameworks, namely: OSI (Open System Interconnection) Model, DoD Model, and TCP/IP Protocol Suit.

### SUMMARY OF THE INVENTION

Briefly described, once again, the invention includes a unique computer implemented logistics data management tool/technique for secure resident operation on a mobile computerized device—and associated system and computer-readable storage medium having stored thereon, executable program code and instructions—encompasses certain cornerstone modules: product generation module; data update module; and secure services module.

### BRIEF DESCRIPTION OF DRAWINGS

For purposes of illustrating the innovative nature plus the flexibility of design and versatility of the new system and associated technique, as customary, figures are included. One can readily appreciate the advantages as well as novel features that distinguish the instant invention from conventional computer-implemented tools/techniques. The figures as well as any incorporated technical materials have been included to communicate the features of applicants' innovation by way of example, only, and are in no way intended to limit the disclosure hereof.

FIG. 1, diagrammatically depicts the Model—View—Controller (MVC) design paradigm 10 embraced by the tool/technique and system of the invention.

FIG. 2 is a high-level schematic illustrating the interoperation of steps 20 for production of a data volume (the terms ‘data volume’ and ‘data set’ used interchangeably throughout) utilizing a unique Etched Compass File (herein referred to as “.ECF” or “ECF”) structure. Shown in FIG. 2 are steps for create(ing), produce(ing), test(ing), and (eventually, by a user of the mobile device) use(ing) the logistics data volume produced according to the product generation module 20 of the invention.

FIG. 3 is a schematic identifying groupings of product descriptive data within an ECF, having attributes as labeled and diagrammed into groups/categories as shown and labeled 30, by way of example only.

FIG. 4 diagrammatically 40 represents an embodiment of components making up .ECF 42. Since the production (30, FIG. 3) of a portable media product (e.g., a data volume resident on a mobile device) has many component-modules resident at or on the source site/server where the data volume was produced or updated, uniquely as diagrammed here, the instant invention uniquely employs use of a single, comprehensive ECF (center oval, 42) as opposed to requiring one ECF for each phase of production of a portable media product (such as, data volume resident on a mobile device).

FIG. 5 diagrammatically 50 represents—by way of an array of boxes containing descriptions—content listings of various examples of static sections within a comprehensive ECF such as that represented by center oval 42, FIG. 4.

FIG. 6 diagrams 60 both a static section 62 and a dynamic section 64, in abbreviated fashion, illustrating the flexibility of employing a comprehensive ECF, according to the invention. As noted, there are five questions posed as shown in FIG. 6, each associated with an example instruction. The novel structure of the ECF, employed according to the invention, allows for dynamic specification of sections within sections and dynamic description of attributes within sections.

FIG. 7—is a flow diagram 70 illustrating how Differential UpDates (UPD's) are used in ‘occasionally connected’ as well as ‘connected’ user environments, as detailed herein.

FIG. 8—diagrammatically 80 illustrates a module/process for query and updating source data volumes, by targeting a specified table therewithin; for example, a table within a master volume is referred to as “TAB”.

FIG. 9—is a high-level schematic 90 of PIPE delimited files—where P represents successive productions and D indicates the applied differences—that undergo comparison as shown: P1 is compared to P2 and the difference, D1, captured. P2 is compared to P3 and the difference(s), D2, captured. P3 is compared to P4 and the difference(s), D3, captured, and so on.

FIG. 10—in a manner similar to that represented in the FIG. 9 schematic 90, FIG. 10 is a high-level schematic 100 of CCITT differentially encoded files, representing successive productions P compared and resultant applied differences, D, as shown: P1 is compared to P2 and the difference(s), D1, captured. P1 is compared to P3 and the difference(s), D2, captured. P1 is compared to P4 and the difference(s), D3, captured, and so on.

FIG. 11 is a chart 110—TABLE B in applicants' provisional application—consisting of a series of bar graphs identifying data samples from live production data obtained testing features of the invention; as labeled, data for six production update cycles—represented by P1-P6—for both PIPE delimited files (“PIPE”) and CCITT (“CCITT”) differentially encoded files.

FIGS. 12A-12D outline and delineating features of four different services (labeled CSaas, SaaS, PaaS, IaaS) that operate in one or more various mobile device communication environments: disconnected, connected, and occasionally connected.

FIG. 13 is a high-level flow diagram outlining certain features of a security services module 130 of the invention.

### DESCRIPTION DETAILING FEATURES OF THE INVENTION

By viewing the figures incorporated below, and associated representative embodiments, along with any technical materials such as ATTACHMENT A, one can further appreciate the unique nature of core as well as additional and alternative features of the new security services module, system, and associated technique disclosed herein. Back-and-forth reference and association will be made to various features represented by or identified in the figures.

Below is a summary list of acronyms used throughout, followed by a description:

ASCII American Standard Code for Information Interchange

CAC Common Access, Card

CCITT Commite' Consultatif International de Telegraphique et Telephonique. (Consultative Committee on Telecommunications and Telegraphy)

CSaaS Clear Sky as a Service

CUI Controlled Unclassified Information

DoD Department of Defense

ECF Etched Compass File

EH Event Horizon (Table in WARP 1 Database)

FOUO For Official Use Only

3G Third Generation Communication Services (wireless)

4G Fourth Generation Communication Services (wireless)

HSPD-12 Homeland Security Presidential Security Directive 12 IaaS Infrastructure as a Service

IIAM iNDIXIUM™ Identify and Access Management protocol (a trademark and service mark brand identifier owned Synergetics Incorporated, the assignee hereof)

iOS Internetwork Operating System

IPSec Internet Protocol Security

LAN Local Area Network

MC Mission Control (Table in WARP 1 Database)

MVC Model—View—Controller

PaaS Platform as a Service

PII Personal Item Identification

PIN Personal Identification Number

PKI Public Key Infrastructure

RDBMS Relational Database Management System

SaaS Software as a Service

SDLC Software Development Life Cycle

sFTP Secure File Transfer. Protocol

SQL Structured Query Language

SSD Solid State Drive

SSL Secure Socket Layers

UDID Unique Device Identification Number

VPN Virtual Private Network

Wi-Fi Wireless Local Area Network devices based on the IEEE 802.11 standards

WAN Wide Area Network

The instant unique tool/security services module—utilized as an integral part of a method or computerized system—is operable on a smart mobile device to access and manage a wide variety of data sets/volumes, of a variety of sizes. By way of example, only, a non-exhaustive list of data volumes/sets contemplated herein include: Controlled and Unclassified Information (CUD, miscellaneous volumes or sets of information tagged or identified as ‘confidential information’ to be held in confidence by an entity, data tagged For Official Use Only (FOUO), as well as data and information maintained to be publicly accessible. Further, the flexible tool is operable both in a ‘connected environment’ (i.e., the mobile device is within range to directly access, and does in fact directly access whether done so in a wireless or wired fashion, a Local Area Network, LAN, or Wide Area Network, WAN, such as the INTERNET), or in a ‘disconnected environment’ (i.e., those times when the mobile device is not in direct communication with a LAN nor a WAN, whether the mobile device is within range of a network). Thus, a smart mobile device in the field that is in wireless contact with a remote processor is considered operating in a connected environment.

The tool/security services module of the invention is suitable for use with a Common Access Card (CAC) or other known agency/corporation authentication for use of logistics data on mobile devices/smart phones. Full utilization of the tool/security services module may dramatically improve the ability of a logistician, such as one or more ground troops in the field, an on-site emergency-rescue facilitator (such as a member of an expedition or natural disaster rescue team performing at-the-scene search & rescue, clean-up, or securing of an area), a member of construction crew (roadway or buildings) on-site and in need of logistics data, a member of a ship's crew (e.g., Navy) on-board an ocean bound vessel, a member of a flight crew (e.g., commercial team or air force) in transit, and so on, to access, process and use logistical data in a timely manner, whether the logistician is in a ‘connected environment’ and/or ‘disconnected environment’.

Smart mobile device as used herein is intended to include a wide variety of portable electronic devices having a user interface for accepting input, such as a keypad, touch screen, stylus and screen, voice activated interface, mouse, touchpad, and so on, a display to communicate retrieved data/information, a computerized processing unit in communication with memory, data storage capability, and an external communication link/capability (wireless, and in some cases, wired). Portable electronic devices on which the tool is adapted to operate include handheld computers with cellular and/or wireless broadband capabilities and/or wireless Wi-Fi capabilities (often referred to generically as a personal desk assistant, or “PDA”), cellular telephones (“cell phones”), tablets, notepad and netbook computers of a wide variety of shapes, sizes, and functionalities.

A smart mobile device on which the tool is adapted for operation preferably incorporates existing features and functionalities adaptable for wireless connection from a ‘remote’ location. The unique tool/security services module is preferably operable in connection with communication protocols such as: Wi-Fi (Wireless Local Area Network devices based on the IEEE 802.11 standards), Virtual Private Networks (VPN), Secure File Transfer Protocol (sFTP), HTTPS, 3G, 4G, whether communication is considered ‘peer-to-peer’, accomplished in the more-traditional client-server model, interconnected by taking advantage of a grid computing model, or communication is within a ‘cloud’ computing environment. Cloud computing is a term used to describe Internet-based (or other. Wide Area Network) computing, whereby shared resources, software, and information are provided to computers and other devices on demand. The tool/security services module of the invention has the capabilities to operate seamlessly in a continuously disconnected, otherwise referred to herein as ‘clear sky’, environment by utilizing unique techniques to secure data resident on a smart mobile device.

The unique tool/security services module is featured with a security capability to maintain security through each information technology layer including the layers referred to herethroughout as infrastructure, platform, application and transport layers as well as to secure data throughout its lifecycle. The tool/security services module of the invention is not only flexible, but maintains features that make it compliant to, and in many aspects exceeds, Federal U.S. Government standards and directives covering securing the confidential nature of the data sets managed.

One will appreciate the distinguishable features of the system and associated technique/tool/security services module described herein from those of known logistics management techniques where data accessed is resident and remains on a host/server, the cloud, or elsewhere (e.g., Internet), including prior designs invented by one or more of the applicants hereof. Certain of the unique features, and further unique combinations of features—as supported and contemplated herein—may provide one or more of a variety of advantages, features, and benefits. The instant unique tool—utilized as an integral part of an existing tool or computerized system—in operation, and depending upon configuration and implementation, may exhibit one, or a combination, of the following features and benefits: (a) substantial data compression of original logistics database files, up to 90%; (b) access database on cellular device or through cloud; (c) asynchronous downloading of data; (d) background/multi/threading; (e) query engine adaptable for optimization; (f) Secure Transport and memory layers; (g) customizable; (h) graphic interfaces capable of optimization; (i) utilization of the security protocol tool as an ongoing service; (j) adaptable for one or more communication protocols available, such as Wi-Fi, 3G, Fourth Generation Communication Services (4G), VPN, Https, sFTP; (k) runs utilizing available memory in cellular phone (smartphone) or tablet; (I) quick response times on the order of a fraction of a second; (m) adapted for ‘connected’ and ‘disconnected’ environments; (n) capability of creating product subsets dynamically; (o) adapted to operate with a wide variety of display technologies; and (p) adaptable for secure connection employing a multitude of protocols and services, e.g., CSaas, SaaS, PaaS, and IaaS.

The system and associated technique/tool incorporates novel application design, product generation, data updating, and secure data transfer, download, and upload services. More-particularly, and as detailed throughout, the computer implemented logistics data management tool/technique for secure resident operation on a mobile computerized device, encompasses certain cornerstone modules: product generation module; data update module; and secure services module.

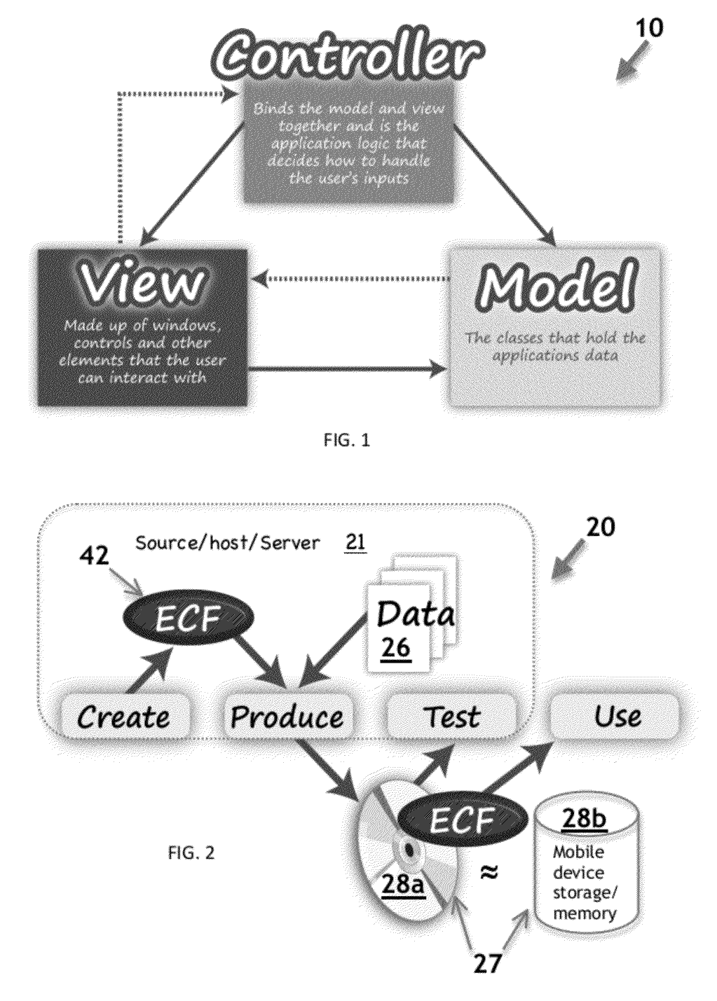

As shown in FIG. 1, the system and tool embrace the Model—View—Controller (MVC) design paradigm. The architecture chosen for the tool permits flexibility and use across a variety of different computer operating systems and platforms with the capability of minimizing source code revisions and development. The ‘View’ box represents use of components comprising windows/screens, user-interface controls and other elements with which the user interacts. The platform-specific development environments and utilities employed by the tool enable efficient utilization of platform-specific features. The box labeled ‘Model’ represents the use of a suitable standard, e.g., Structured Query Language (SQL), for database access. And, to round out the MVC design paradigm as diagrammed in FIG. 1, the box labeled ‘Controller’ represents the interconnection of the View and the

Model with specialized application logic and business rules. It is the Controller application logic that determines how to handle user input.

Additionally, the Controller interconnects the View and the Model with a pre-defined rule base constructed by means of a unique file of program directives and attributes. This file ensures consistent access to on-line or off-line databases as well as interface consistency. With a feature-rich description of product creation, production and usage, forward and backward compatibility are maintained across multiple platforms even embracing platform specific functionality; see FIG. 1.

The system and associated technique/tool incorporates a pre-defined rule base of program directives and attributes. The FIG. 2 preferred embodiment highlights a process for production of a data volume/data set utilizing a unique Etched Compass File (.ECF) structure. The .ECF structure is modeled after and built as a configuration file type. Conventional configuration files store settings and configuration information. Shown in FIG. 2 at 20 are steps for create(ing), produce(ing), test(ing), and subsequent (eventual) use of—by a user of the mobile device—the compressed logistics data volume 27 produced according to the product generation module of the invention. The logistics data volume 27 can be stored onto media 28a (e.g., DVD, Flash drive, or other portable external physical media) but will more-often be downloaded and resident on a portable/mobile device 28b.

Referring back to the FIG. 1 depiction of the MVC design paradigm 10: The pre-defined rule base embodied by the Etched Compass File (ECF) is employed by the Controller to ensure consistent access to on-line or off-line databases held in the Model as well as to encourage user interface consistency in the View. The rule base embodied by the unique .ECF structure provides a feature rich description of product creation, production and usage that enables the new tool of the invention to maintain forward and backward compatibility across multiple platforms while embracing platform specific functionality.

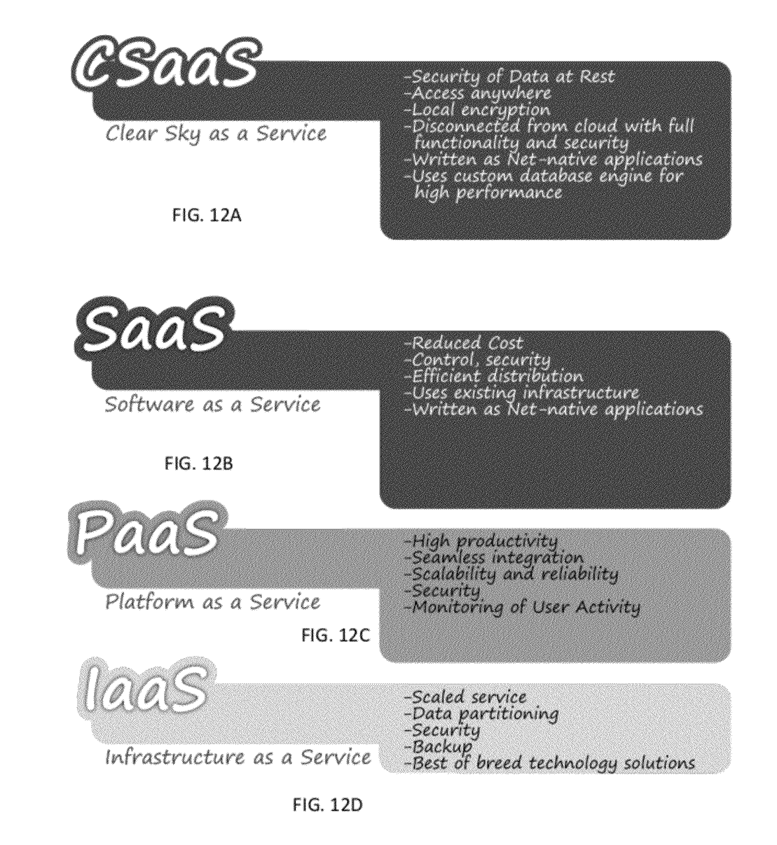

The unique adaptation of the MVC application design along with the pre-defined rule base employed by the invention, make the unique tool independent of programming language or computer platform operating system and hardware. This enables the new tool to be embodied in Objective-C on Apple Internetwork Operating System (iOS) devices, Java on Android-based devices, .NET on Windows Phone 7-based devices, and other such known—and yet to be devised—mobile application environments (see technical discussion of CSaaS, FIG. 12A, “Clear Sky as a Service” and elsewhere).

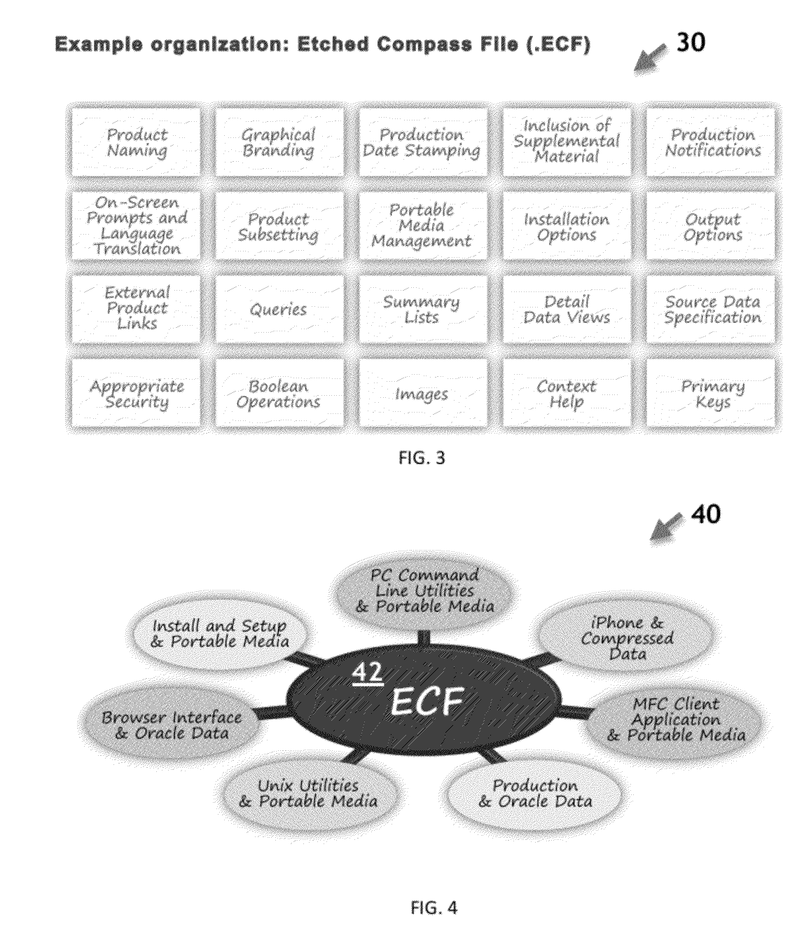

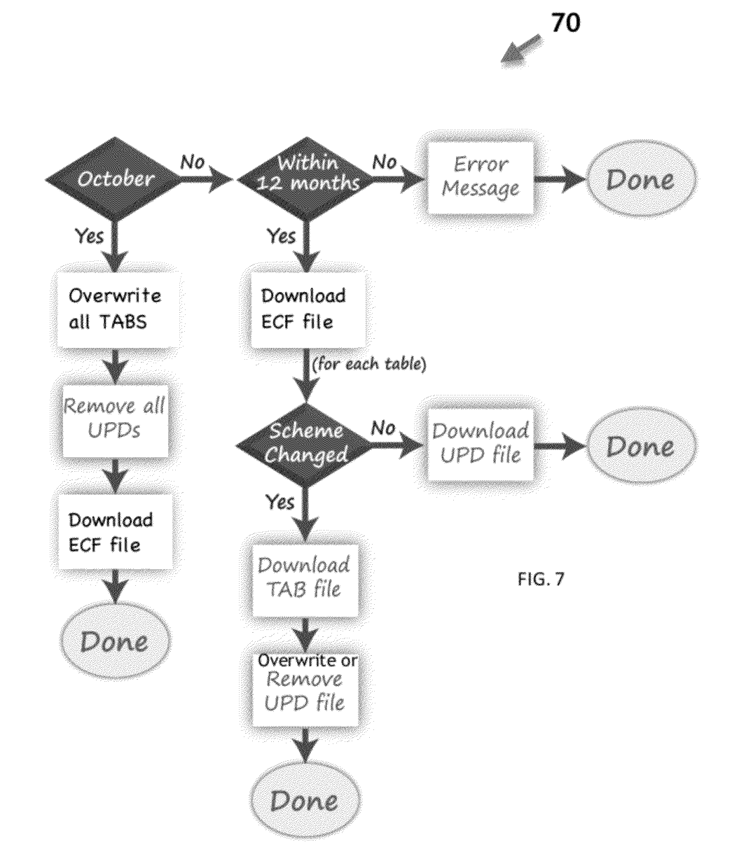

The product generation process, i.e., product generation module 20, packages application features and dependent data prepared for known user communities. This product generation module employs a complete specification of an initial data volume ‘product’ (e.g., a volume of data of all authorized replacement parts for jet engines) within a single entity (e.g., an airline engine repair subcontractor) so that all ‘product’ attributes (attributes of the data volume) are available in one location as an initial uncompressed data volume of records 26. Each subsystem develops or accesses the appropriate information within a product specification during initial compressed product generation, as well as subsequent updates thereafter generated by the product generation module. A cornerstone of the data volume/product generation module of the logistics data management tool of the invention is the Etched Compass File (.ECF) structure 40/42, uniquely adapted for use as a multi-product generation module. While the .ECF designed for the data volume generation module has attributes of a configuration file, the .ECF defines application data schema adapted to be read during runtime (on-the-fly). Conventional configuration file data schema is static, such that the application code must be changed and the application recompiled in order to change a data schema. Further details describing the novel .ECF structure 40/42 are found, throughout, in connection with FIGS. 3, 4, 5, and 6, and use thereof in FIG. 7.

The data update module of the new logistics tool has the capability of rapidly updating data when a user ('customer') of a smart mobile device connects their device to the cloud services, for example. The capability to isolate and download only data that has been generated (and subsequently) updated at its source—rather than downloading a full data set(s)/volume—dramatically decreases the time needed to synchronize the data once resident on the mobile device with the enterprise data. The data update module incorporates the use of compressed data and produces a UPD file consisting of ADC's for rapid data communication and efficient storage on the mobile device. This unique data update module also includes functionality that enables a user to occasionally connect to the cloud data services, or connect peer-to-peer or to a host via the Internet, etc., update their mobile device, then disconnect from the cloud data services, etc., and continue to use the unique tool on their mobile device.

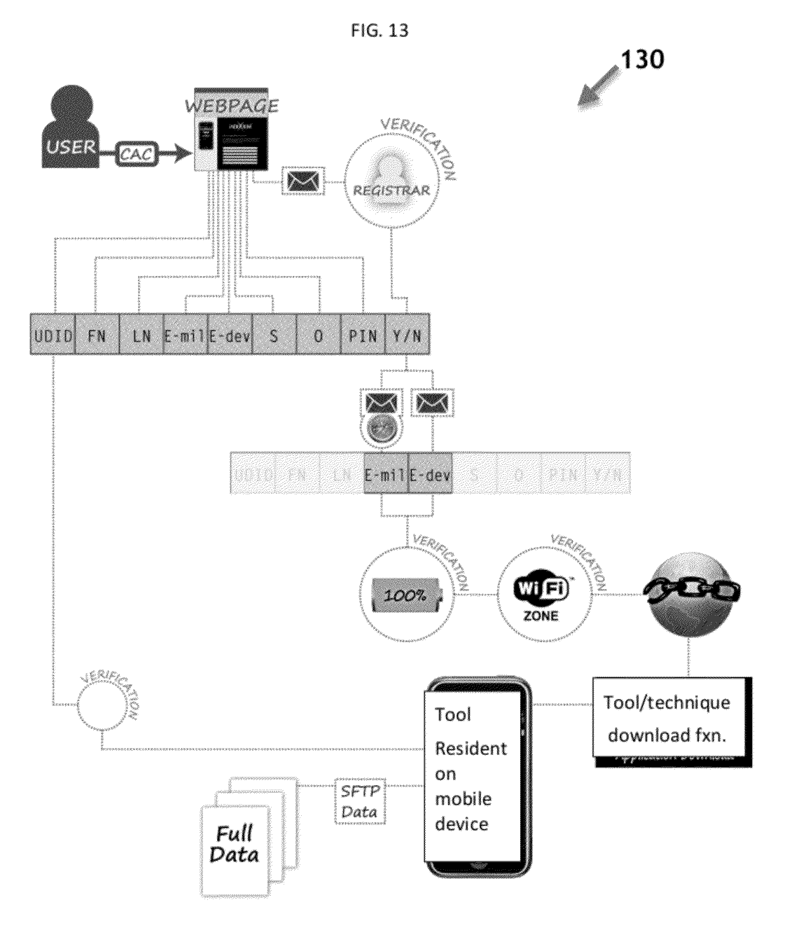

The secure services module of the tool (see, FIG. 13, 130) is designed to guard and protect against a broad variety of threats and challenges. Employing a unique security protocol, the secure services module protects confidential, or otherwise sensitive or restricted-access, data to be served through a smart mobile device. The unique security protocol manages each condition of the data including: data-in-transit, data-at-rest, data lineage, data provenance, and data remanence. The secure services module implements security through each applicable layer of the tool, including the infrastructure layer, platform layer, application layer, network/transport layer, and device layer in the case of OSI Model and the application, transport, internet, and network access layer in the case of TCP/IP Model (DoD Model). By way of further background reference, only, ATTACHMENT A includes brief technical description of the layers of common networking protocol frameworks OSI (Open System Interconnection) Model, DoD Model, and TCP/IP Protocol. Suit. The networking protocol framework implements networking functionality between respective operating system of computerized systems/units in communication, such as a host server and a smart mobile device.

As mentioned, the Etched Compass File (.ECF) structure 40/42 is uniquely adapted for use as a multi-product generation module, as will be better appreciated in connection with the following discussion referencing FIGS. 3, 4, 5, and 6. While the physical characteristics of an ECF structurally adhere to open source utilization, the instant adaptation and comprehensive structure of the .ECF 42 is unique and robust. The ECF is adapted for a multi-product/sub-product production system, by establishing groupings of product descriptive data, having attributes as diagrammed into groups/categories shown in FIG. 3, by way of example only.

While the groupings listed 30 in FIG. 3 are not all inclusive, FIG. 3 frames the breadth of power of the ECF. An ECF, as utilized according to the invention in generating/production of source data volume and/or updates to the source data volume, is unaltered from platform-to-platform and from operating system-to-operating system, enabling parallel development for platforms or operating systems with a consistent rule base.

The ECF is a single machine-readable file that can be manually generated, e.g., entering records and field data by hand, or programmatically generated, e.g., by way of employing software for authoring/generating files. Once generated as such and according to the invention, an ECF is available for use to produce specific databases given any SQL based Relational Database Management System (RDBMS) as its source. As enhancements to an original data volume are requested or required (e.g., a data volume of aircraft engine parts needs two more data fields defined within each record of replacement jet engine parts) the ECF can be readily updated. The ECF is also used for subsequent productions of source data volumes. Each production replicates the ECF on all produced portable media.

As diagrammed 40 in FIG. 4, preferably ECF 42 is comprehensive. Since the production of a portable media product 27 (i.e., a data volume 27 resident on a mobile device of some sort 28b, or resident on physical media 28a) has many component-modules resident at or on the source site/server where the data volume was produced or updated (each of the component-modules having entries in the ECF), the instant invention advantageously employs use of a single, comprehensive ECF (e.g., center oval 42, FIG. 4), effectively operating as a ‘go-to’ file where the component-modules can go, to look for guidance) as opposed to requiring one ECF for each phase of production of a portable media product/data volume.

With comprehensive specification of a source data volume 26 (i.e., ‘product’) found within a single comprehensive file (center oval, FIG. 4), all attributes are in one ‘location’, i.e., within the comprehensive ECF. Each component-module can glean its appropriate information and perform updates to the ECF, as necessary. This enables end-to-end production performance as well as documented restart capability.

Structurally, the comprehensive ECF 42 is preferably generated, according to the invention, as American Standard Code for Information Interchange (ASCII) text files with a carriage return line feed following each line. Each section conforms to Windows INT formatting guidelines and order of the sections is not important. Each section name is enclosed within brackets and contained on a line by itself. Any subsequent attribute(s) are automatically applied to that section until the next bracketed section. Each subsequent non-section line must contain an attribute followed by the equal sign (i.e., the symbol “=”) followed by the pertinent information associated with that attribute. Multiple information fields within a data record of an ECF may be delimited by commas. While the following examples of .ECF sections (labeled, for reference only, Section A and Section B) are valid and conform to the Windows® INI file structure, they serve as a syntax samples, only:

### [Section A]

AttributeA=Text string
AttributeB=Text string, Info=data, MoreInfo=more data
AttributeC=Text string

### [Section B]

AnotherAttributeA=Text string, More text
AnotherAttributeB=Text string

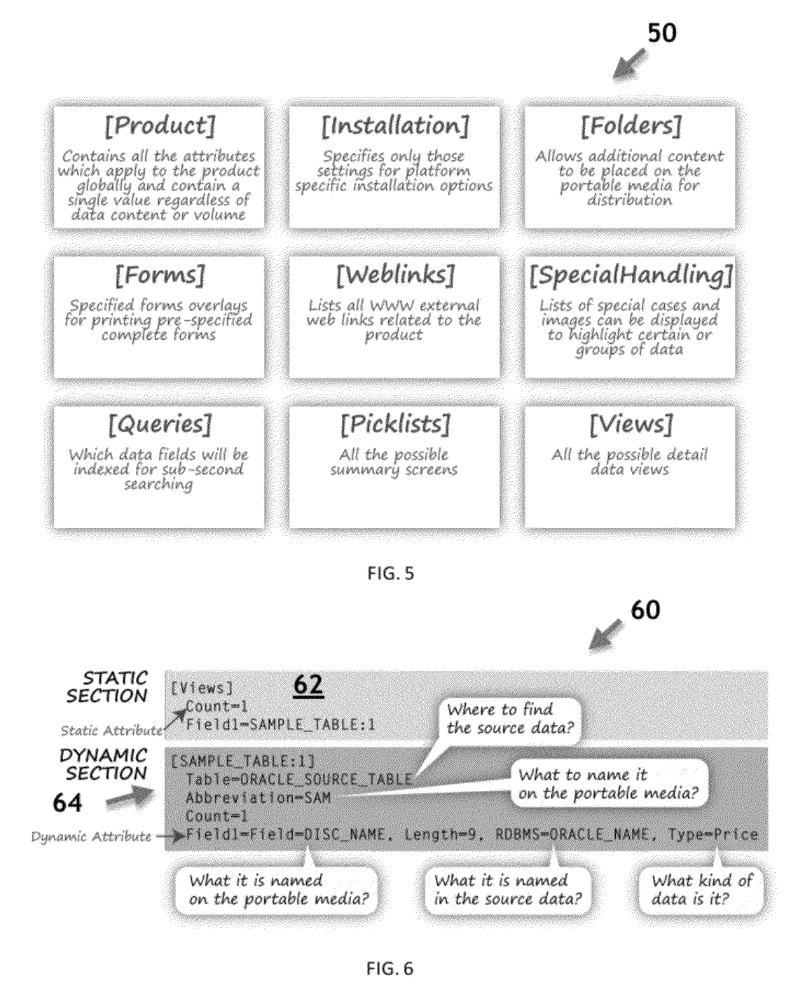

FIG. 5 diagrammatically 50 represents—by way of an array of boxes containing descriptions—content listings of various examples of static sections within a comprehensive ECF such as that represented by center oval 42, FIG. 4. In addition to the static sections defined by the boxes of array 50, the ECF allows for dynamic specification of sections within other sections and dynamic description of attributes within sections as highlighted in FIG. 6. FIG. 6 diagrams 60 both an example static section 62 and dynamic section 64, in abbreviated fashion, illustrating the flexibility of employing a comprehensive ECF, according to the invention. With the five questions posed in a dynamic section of an .ECF answered, components of a wide variety of software applications are able to read or write to the .ECF; whether it be production software or client application software, the ECF knows where to find the data, what it is named and how it is accessed or displayed. Dynamic SQL can then be created on-the-fly. to access data either through a RDBMS or compressed portable media files.

Components accessing the comprehensive ECF once created, preferably use one of two structures, regardless of platform or operating system:
1—Read from ECF: Value=GetValue using Section, Attribute, Optional information and Data
2—Write to ECF: CreateValue using Section, Attribute, Optional information and Data

The unique application of the ECF to the MVC development paradigm (10, FIG. 1) creates an opportunity for even further efficiencies. Generally, to move to a new platform simply requires new code/steps for arranging particular data being displayed on the “glass” along with employing the “Read from ECF” and “Write to ECF” functions (noted above). Other functionalities of the tool, remain unchanged.

Users of the logistics data management tool/technique generally fall into three broad environment categories: Connected environment, Disconnected environment, and Occasionally Connected environment. A summary of each is provided, by way of example:

### Category 1—Connected

‘Connected’ users include those who maintain an active—most-often, wireless—connection to the Internet and prefer to access database though the World Wide Web. In this context, differential updates are performed behind-the-scenes continuously, such as during prescribed intervals or ongoing, and seamlessly. These updates are performed by external processes or manual inputs directly to the database. This function is performed on the active database tables. Users access the application and perform queries as usual without any need to personally take independent action to update the database they are using. The “differences” are applied to the on-line database as part of normal business updates (ordinary and customary gathering of logistics data).

### Category 2—Disconnected

Continually ‘disconnected’ users include those who require and use the complete database/data volume, but have no means to receive electronic updates and who manage (access/retrieve and update data) the tool's database via physical means (US Postal Service on CD, DVD, SSD, or other storage media, or the like) are considered ‘disconnected’. Differential updates are not made in this case, since the entire database is received physically (CD, DVD, SSD, and so on). A user accesses the tool, loads the data from the physical media, then performs queries of the database in customary/conventional fashion.

Category 3—Occasionally connected

‘Occasionally connected’ users receive the physical database wirelessly, or via wired communication, and then leave their primary location for an extended period of time. While away, users may occasionally connect to the Internet through Wi-Fi or even an external LAN. At these times, users may download the database differentials since their last connectivity. The ability to download the differentials (i.e., only that part of the full database that has been identified as having been updated) rather than the full database, dramatically decreases the time to synchronize the database. It is rare that an, ‘occasionally connected’ user will attempt to download the entire database upon each connection.

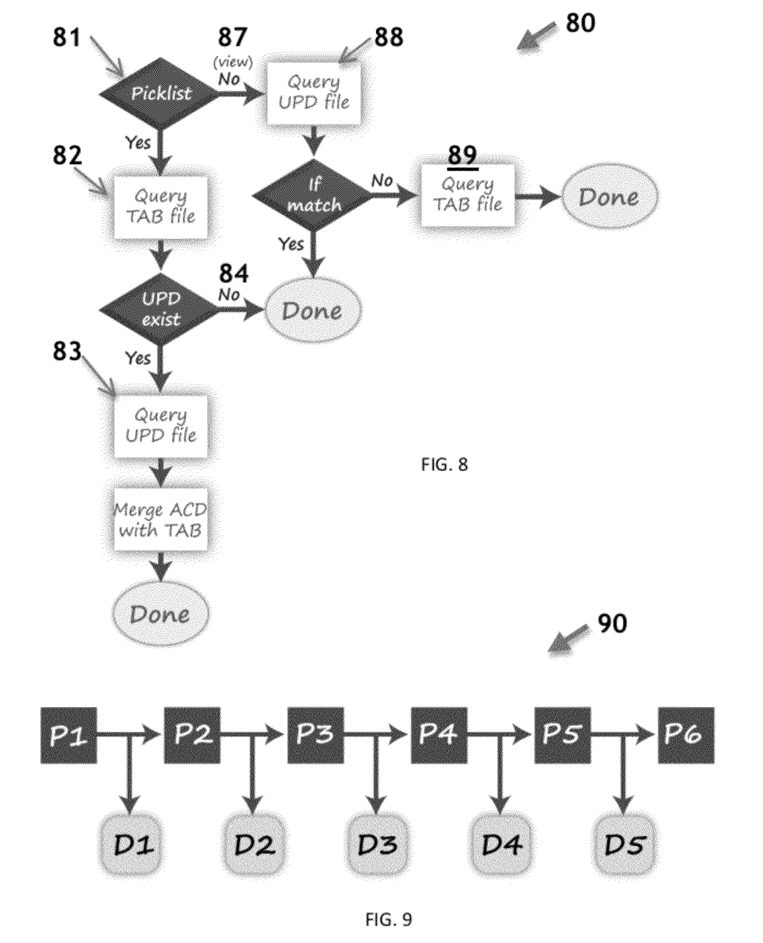

Differential updates are generally of greatest interest to the category of ‘occasionally connected’ users as specified and detailed schematically in the FIG. 7 flow diagram. FIG. 7 diagrams a process 70 for making a query at a particular time, here for example, a time in. “October”, for differential updates (“UPD”) made to a source master data volume such as that represented at 26, FIG. 2. For purposes of this discussion, and as labeled in FIG. 7 and FIG. 8: “TAB” designates one, of many, tables within a source master data volume; and “UPD” represents any ‘updated data volume’ resident on the source server/site that had been produced and dated after the latest data volume currently residing on a user's smart mobile device (having been accessed and downloaded to the user's mobile device earlier), at the time the query is being made (e.g., a day/time in October).

Data received by mobile devices is typically CCITT differentially encoded PIPE delimited text; and as noted elsewhere, CCITT is an acronym for Commite' Consultatif International de Telegraphique et Telephonique. Each row is a variable length ASCII string terminated by the 0×0A line feed character. Each information field within a data record for differential updates is delimited by the pipe ‘|’ character, as demonstrated below:
Row1Val1|Row1Val2|Row1Val3
Row2Val1|Row2Val2|Row2Val3
RowNVal1|RowNVal2|RowNVal3

These RDBMS (Relational Database Management System) data sources are extracted to flat files, sorted and then compressed by comparing successive rows (i.e., data records) against the other and storing only the differences. This same operation is applied to all successive rows (i.e., data records) throughout the entire file. Index information is extracted, compressed in the same fashion and added to the compressed data for a complete stand-alone SQL replacement database.

Conventionally, compressed database tables are grouped into two categories: summary tables (occasionally referred to, or designated in the figures, simply as “summaries” or “picklists”) consisting of a subset of data records with summary information; and view tables (occasionally referred to, or designated in the figures, simply as “views”) consisting of all data records and their full complement of data fields. ‘Summaries’ are used to perform any queries against the entire combined database. They contain abbreviated information enabling the user to query and select their ultimate results based on summary information (also called “picklists” which includes selected data fields within the records, as opposed to ‘view tables’ which include the full complement of data fields provided for each data record). Summary tables contain indexes for all display columns. Conversely, ‘views’ contain the complete grouping of data fields but are only indexed by a single primary key column. While these attributes, in-and-of-themselves taken alone, are not unique to database management, enabling queries of summary tables along with view tables allows business knowledge use, when merging into the original source for combined queries.

While, summary tables and view tables are standard in RDBMSs, it is the knowledge and consistency of selection and validation of a single primary key—i.e., selected out of a picklist/summary table—which enable the summaries (consisting of a subset of data records with summary information) and views (all data records and their full complement of data fields) to be connected, and enables optimal compression.

Turning to process 80, FIG. 8, considering each table (i.e., represented as TAB) within a compressed master volume (such as 27), row-by-row (i.e., data record-by-record) comparisons are applied to successive portable media productions 27 (i.e., data volume resident on a user's mobile device 28b or stored on external physical media 28a). Starting from upper left-hand corner 81, the picklists (or summary tables) are queried. From any given summary TAB 82 (i.e. query table within a master volume/production), the next production (TAB) can be considered as a sequence of ADD, CHANGE, and DELETEs—i.e., “ACD”—applied to its predecessor TAB.

As noted in FIG. 8, when querying summary tables, searches are performed against the original source data TAB's 82 and then against the differential update (UPD) 83. After a stable set of matches retrieved from the original data (i.e., TAB), the ADDs, CHANGEs and DELETEs (ACD's) are applied to that set (i.e., current TAB) for the updated correct summary (i.e., UPD). If no matches 84 are retrieved from the original source (TAB), any ADDs are retrieved as the correct summary (nothing in TAB, and query is DONE).

Once the module has selected specific rows/records within the TAB and the UPD to arrive at an updated version of the summary tables (consisting of a subset of data records with summary information), the view tables 87 (which include the full complement of data fields provided for each data record) are queried by searching the differential update (Query UPD file 88), first. If any matches are located, the query is complete and the data is displayed. If there are no updates, the original source table of interest is queried (Query TAB file 89). For view tables, there can be one or more rows for a given primary key (as specified by ECF). If this is the case, all rows are included in the differential file (UPD) for that primary key.

While the creation and query rules have been specified above, delivery of the differential update (UPD) can be accomplished by two means. One is to deliver PIPE delimited files and one is to deliver CCITT differentially encoded files.

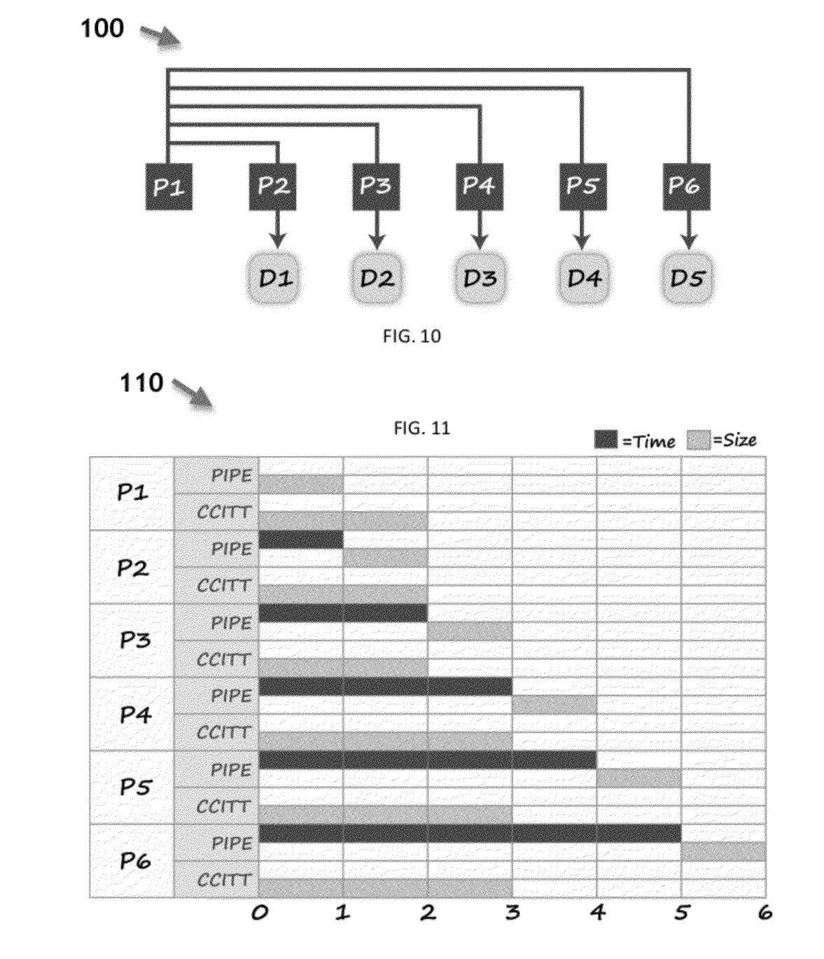

Creation of the differences is illustrated by the schematic flow diagrams FIG. 9 at 90 and FIG. 10 at 100, where P represents successive productions and D indicates the applied differences. TABLE A, immediately below, sets out the differences in attributes of PIPE Delimited files and CCITT Encoded files, according to the invention:

TABLE A

| attribute | PIPE Delimited Files | CCITT Encoded Files |
|---|---|---|
| Size | Smaller text files | Larger but compressed |
| Creation | Production to production differences | Differences as compared |
| | | to the baseline |
| Processing | Differences merged into a cumulative | None, download only |
| | difference file | |
| Access | Slower linear scan | Faster compressed index |

FIG. 9—is a high-level schematic 90 of PIPE delimited files—where P represents successive productions and D indicates the applied differences—that undergo comparison as follows: P1 is compared to P2 and the difference, D1, captured. P2 is compared to P3 and the difference(s), D2, captured. P3 is compared to P4 and the difference(s), D3, captured, and so on.

FIG. 10—in a manner similar to that represented in the FIG. 9 schematic, FIG. 10 is a high-level schematic 100 of CCITT differentially encoded files, representing successive productions P compared and resultant applied differences, D, as follows: P1 is compared to P2 and the difference(s), D1, captured. P1 is compared to P3 and the difference(s), D2, captured. P1 is compared to P4 and the difference(s), D3, captured, and so on.

When selecting the most appropriate methodology to deliver delta data differences to the mobile device, two factors weigh heavily on the decision: SIZE and TIME. SIZE refers to the number of bytes which would be required for WiFi transmission and TIME refers to the processing time required by the mobile device to reassemble the delta data for efficient queries. After prototyping both methods and applying equal weight to each method, CCITT delivery provided results promising more-optimal delivery of delta difference data for databases on mobile devices.

The bar graph chart 110 in FIG. 11 (also set forth and labeled “TABLE B” in the specification of applicants' Prov App No. 61/392,468) contains data samples collected from live production data. Each number is represented in a weighted time calculation where size is the estimated number of minutes to transfer and time is a weighted calculation of CPU cycles converted to minutes. Six production update cycles are illustrated in FIG. 11.

As shown at the top bar graph P1, one can appreciate that the PIPE difference file is the weighted favorite as there is no processing necessary for the first difference file. And while the CCITT file is compressed, there is a minimum overhead that is not overcome until two or three data updates have occurred. As production continues, each. PIPE difference must be merged into the previous cumulative difference merge file. For the purposes of the composite bar graph in FIG. 11, this grows linearly over time until the entire database is reinstalled to the device, even though the size of the pipe difference remains constant. While the CCITT file is larger to download, there is zero processing on the mobile device as the differences have already been cumulatively merged on the host. This file does not grow as fast as the PIPE path due to the compression applied.

If the individual bar graphs had ended up with no appreciable differences, user query speed would be taken into account and searching the CCITT compressed data method would be used because it is magnitudes faster than any type of scan through delta PIPE files. When looking at risk for either solution, applying PIPE differences requires linear application of differences. In other words, difference 1 must be applied before difference 2 and before difference 3, etc. If for any reason any of these updates are missed, the complete database can be irreparably damaged. Application or pre-processed cumulative differences, while somewhat larger over time, will overlay the exiting update and mitigates database damage.

The security services module of the logistics data management tool/technique of the invention is designed with protocol that targets against a broad variety of threats and challenges to confidential, sensitive, or otherwise restricted data served through a smart mobile device. The high level schematic/system diagram 130 of FIG. 13 depicts features of a preferred security services module. The secure services module implements security measures through each of a plurality of ‘layers’ of the tool, including an infrastructure layer, platform layer, application layer, network/transport layer, and device layer. Another unique feature of the logistics tool/technique is the manner in which the secure service module secures data. The security module's protocol manages each of a plurality of conditions of the data including: data-in-transit, data-at-rest, data lineage, data provenance, and data remanence. The protocol of the security services module includes a comprehensive Identity and Access Management (IIAM) module that is compliant with M-04-04 E-Authentication Guidance for Federal Agencies, Federal Public Key Infrastructure (PKI) and PIV-I Cross Certification policy requirements including X.509 Certificate Policy for the Federal Bridge Certification. Authority. The tool also enables CAC authentication for use of logistics data on mobile devices/smart phones, while considering DoD Personal Item Identification (PII) guidelines.

As mentioned elsewhere, the logistics tool/technique is adapted to function in a disconnected environment from the Cloud computing services in what has been coined a “Clear Sky” service environment (see schematic FIG. 12A outlining CSaaS functionality). The complete database can reside on the smart device including all summary screens, views and supporting images. In this configuration, all data is accessible without requiring a wireless connection to the WAN (e.g., Internet) or LAN.

At the application layer, the security services module is multi-faceted. It contains relevant aspects of FISPD-12 compliant 2 factor identity management and includes a 3rd factor which is above the current conventional standards. A multi-factor authentication is via delegation which increases it strength. Employment of a hardened browser along with access control makes the application additionally secure. The security module preferably maintains login history for each account and develops and maintains log reports for defective controls. See schematic FIG. 12B outlining SaaS functionality.

In one embodiment of the tool/technique, namely, an iOS implementation of the tool developed in Objective-C, threats are reduced by preventing use of the buffer overflow attacks and SQL injection attacks. While manual memory management is available, preferably, Cocoa objects are used along with integer overflow notifications (if an integer overflow situation is detected). Format String attacks are addressed for prevention by changing the NSLog to an object and all Double Frees are released and set to nil. Sandboxing can be utilized and incorporated into the application procedures to allow for the writing of policies, granting permissions, storing credentials and entitlements, maintenance of keychain mechanisms, provisioning of application, preventing Heap and Stack execution and the prevention of third party code execution through code signing.

At the platform layer, the security services module uses robust user authentication, as well as account management and location services. The tool is adapted for use with a hardened browser. Activity is logged and correlated by event if a challenge or threat is detected. See schematic FIG. 12C outlining PaaS functionality.

Within the infrastructure layer a least privileged configuration is employed. Security-embedded Software Development Lifecycle (SDLC) processes can be utilized in development of the application. The tool is adapted to work within a secure infrastructure layer that controls user authentication, robust user account management, and access control. To provide further security within the infrastructure layer, a prerequisite can be set for two certificates, user and client, before access is granted beyond the infrastructure's firewall. Activity within the infrastructure is logged and correlated by event if a challenge or threat is detected. See schematic FIG. 12D outlining IaaS functionality.

The security services module provides a very unique smart mobile device tool adapted for managing proprietary, sensitive, FOUO and CUI, and such, while securely maintaining all data activity layers. The data activity layers include, as detailed further below: data-at-rest, data-in-transit, data lineage, and data provenance and data remanence. The security assets provided for the tool of the invention by the security services module disclosed herein, include: AES 256 encryption, the use of a complex Personal Identification Number (PIN), ability to remotely remove data from the smart mobile device, the ability to remotely manage the device's configuration and the ability to push to the smart mobile devices updated and evolving security protocols. This includes rolling access management.

When at rest, data is protected by the AES 256 encryption methodology, the complex user authentication with multiple factors, token driven user access to application and data, and the use of the configuration utility to wipe the phone and remove any data in the event of a breach. For example if the device is lost or stolen all data and settings resident thereon at time of theft or loss may be cleared and deleted by issuing a remote wipe command when within a Wi-Fi zone. In a non-Wi-Fi zone, multiple pin failures may be enabled to cause a wipe of all resident data and settings, automatically.

Data transmission from a source data volume (host/server) to a mobile device is considered data-in-transit. It is anticipated that data-in-transit will be performed using known remote/wireless protocol such as Wi-Fi, 3G, 4G, sFTP and VPN. The tool preferably uses an authentication operation and methods of 802.11-based wireless networks and the use of Internet Protocol Security (IPSec) tunnels and Secure Socket Layers (SSL). Upon connecting to a wireless network, the security services module employs a unique protocol that uses both certificate-based authentications teamed with token driven permissions and location services. All connections are managed by using device policies and restrictions plus encryption methods to secure the data. The data is not just encrypted but it is also compressed which creates an additional robust layer of security. Finally, preferably data transmissions are further protected utilizing a unique device identification number (UDID) associated with the mobile device and used to generate the encryption key and ensure that this device has the permissions necessary to connect and transmit the data. This provides confidentiality and integrity of data much like the using a symmetric streaming key cipher.

Data lineage, maintained by the system and tool of the invention, consists of documenting ‘where data is’ (location) and ‘where and how’ data is transmitted to the application, securing the data during transmission. The security services module contains a unique data table within its Warp 1 database called the Event Horizon (EH). The EH maintains all the relevant data relating to the use of the application. This includes documenting events with date, time and user such as application download, version download, data downloads, delta version data downloads, pushed configuration profiles, Internet protocol addresses (IP address), and incorrect pin. Because time of the initiation of the event and the completion of the event is maintained we have a complete view of the data flows. This includes the location of the data, the date of new data versions, the IP addresses used to transmit the data, download dates, and the process times.

Data provenance is closely related to data lineage. Data provenance is information related to the data's origin, key events, data creation, and most importantly the interconnected elements of what, when, where, how, who, which and why. Since the events are maintained in the EH table, Warp 1 has a second table called Mission Control (MC). MC maintains information on the user. Primarily it answers the questions of: Who? Where? and Why?

The system and associated logistics data management tool of the invention preferably provides a ‘secure’ environment for data from the beginning—with the authentication of identifying and defining ‘who’ has permission to access the data being managed—employing IIAM protocol. The protocol is comprised of application security, user access control, multi-factor authentication, role based authorization, trusted sources attributes, single sign on identity federation and user activity and monitoring in the EH.

Generally, no user (without proper permissions and authority) of the mobile device has the ability to make any changes to the data downloaded and accessed/managed. Through a comprehensive information and data assurance procedure, the computational accuracy of the data is continually tested. Any changes to the data are event-logged and can only be done by an assigned role-authenticated administrator having proper permissions and authorization, so that there is no unauthorized access or use of the data. The protocol is adapted to also keep a record of any changes along with computational accuracy thereof.

Finally, the system and associated logistics data management tool provides data remanence. Data remanence is the residual representation of data that remains after the data is either removed or erased. When dealing with sensitive data, inadvertent disclosure is unacceptable. The security services module of the invention employs the technique of overwriting to maintain data remanence. No more than one version of the application or data is allowed to exist (i.e., ‘resident’) on the mobile device at a time.

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the applicants do not intend to invoke 35 U.S.C. §112 ¶116 in a manner that unduly limits rights to its claimed invention. Furthermore, in any claim that is filed herewith or hereafter, any means-plus-function clauses used, or later found to be present, are intended to cover at least all structure(s) described herein as performing the recited function and not only structural equivalents but also equivalent structures.

We claim:

1. A computer implemented logistics data management tool for secure downloading onto, and resident operation on, a mobile computerized device, the tool comprising:
(a) a product generation module for generating a compressed master volume;
(b) a data update module for producing a plurality of differential updates to said volume; and
(c) a secure services module adapted for further carrying out downloading to the mobile device, of at least one of said plurality of differential updates.

2. A system for implementing logistics data management on a mobile computerized device using a logistics management tool adapted for secure downloading of a compressed master data volume onto the device, the tool comprising:
(a) a product generation module for generating a compressed master volume;
(b) a data update module for producing a plurality of differential updates to said volume; and
(c) a secure services module adapted for further carrying out downloading to the mobile device, of at least one of said plurality of differential updates.

3. A computer-readable storage medium having stored thereon, executable program code and instructions for secure downloading to the mobile computerized device a compressed master data volume, comprising: the steps of:
(a) generating the compressed master volume at a host server;
(b) producing a plurality of differential updates to said volume; and
(c) downloading at least one of said plurality of differential updates to said volume;
wherein the mobile device is adapted for the secure downloading in an environment selected from those consisting of Connected, Disconnected, and Occasionally Connected.
